(19) United States
(12) Patent Application Publication
(10) Pub. No.: US 2013/0189491 A1
(43) Pub. Date: Jul. 25, 2013

(54) DISPLAY APPARATUS AND COMPOSITE OPTICAL FILM THEREOF AND MANUFACTURING METHOD OF COMPOSITE OPTICAL FILM

(71) Applicants: Innocom Technology (Shenzhen) Co., Ltd., Shenzhen City (CN); Innolux Corporation, Chu-Nan (TW)

(72) Inventors: Szu-Wei LAI, Chu-Nan (TW); Chia-Lang KAO, Chu-Nan (TW); Hui-Chen HSU, Chu-Nan (TW)

(73) Assignees: INNOLUX CORPORATION, Chu-Nan (TW); INNOCOM TECHNOLOGY (SHENZHEN) CO., LTD., Shenzhen City (CN)

(21) Appl. No.: 13/739,816

(22) Filed: Jan. 11, 2013

(30) Foreign Application Priority Data
Jan. 11, 2012 (TW) 101101048

(51) Int. Cl. G02B 1/10

(52) U.S. Cl. CPC G02B 1/10
USPC 428/172; 427/162

(57) ABSTRACT

A composite optical film is disposed on a substrate. The substrate has a first region and a second region positioned adjacent to each other. The composite optical film includes a first optical film and a second optical film. The first optical film is disposed on the first region, while the second optical film is disposed on the first optical film and above the second region. A display apparatus containing the composite optical film and a manufacturing method of the composite optical film are also disclosed.

### CROSS REFERENCE TO RELATED APPLICATIONS

This Non-provisional application claims priority under 35 U.S.C. §119(a) on Patent Application No(s). 101101048 filed in Taiwan, Republic of China on Jan. 11, 2012, the entire contents of which are hereby incorporated by reference.

### BACKGROUND

1. Technical Field

The disclosed embodiments relates to a display apparatus and a composite optical film thereof, and a manufacturing method of the composite optical film.

2. Related Art

Many electronic products have become indispensable in our lives. Besides, as facing the keen market competition and for satisfying the growing requests of consumers, the appearance of the electronic product also becomes one of the most considered design issues.

FIG. 1 is a schematic diagram of a conventional optical film 1, such as an optical film used in a portable communication device. In general, the optical film 1 is disposed on a substrate 10 and includes a plurality of stacked optical layers 11 and 12. For example, the optical layers 11 and 12 may have different functions such as anti-reflection or filtering.

However, the conventional art can not form the optical layers 11 and 12 with different functions at different regions for satisfying different demands. For example, the substrate 10 is divided into a first region A1 and a second region A2, on which the optical layers 11 and 12 with anti-reflective function are formed. To form this structure, the optical layer 11 is conventionally formed on both the second region A2 and the surrounding first region A1, thereby forming a planar layer. Similarly, the optical layer 12 is also formed on the first region A1 and the second region A2.

As mentioned above, the conventional optical film 1 has the same optical property in different regions, so that it can not achieve the desired design of providing different optical functions in different regions.

### SUMMARY

In view of the foregoing, an objective of the present invention is to provide a display apparatus with composite optical functions.

To achieve the above objective, the embodiments of the present invention disclose a composite optical film, which is disposed on a substrate. The substrate has a first region and a second region positioned adjacent to each other. The composite optical film includes a first optical film and a second optical film. The first optical film is disposed on the first region, and the second optical film is disposed on the first optical film and above the second region.

To achieve the above objective, the embodiments of the present invention also disclose a display apparatus, which includes a main body and a protective substrate disposed at one side of the main body. The protective substrate includes a substrate and a composite optical film. The substrate has a first region and a second region positioned adjacent to each other. The composite optical film includes a first optical film and a second optical film. The first optical film is disposed on the first region, and the second optical film is disposed on the first optical film and above the second region.

To achieve the above objective, the embodiments of the present invention also disclose a manufacturing method of a composite optical film, which includes the steps of: forming a first optical film on a first region of a substrate, wherein the first region is disposed adjacent to a second region; and forming a second optical film on the first optical film and above the second region by a wet manufacturing process.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of a conventional optical film;

FIG. 2 is a flow chart of a manufacturing method of a composite optical film according to an embodiment of the invention;

FIGS. 3A and 3B are schematic diagrams showing the manufacturing procedures of the composite optical film according to the embodiment of the invention;

FIGS. 4A and 4B are schematic diagrams showing the manufacturing procedures of the composite optical film according to the embodiment of the invention;

FIGS. 5A and 5B are schematic diagrams showing different aspects of the composite optical film according to the embodiment of the invention;

FIG. 6 is a schematic diagram of a display apparatus according to the embodiment of the invention; and

FIG. 7 is a schematic diagram of a display apparatus of another aspect according to the embodiment of the invention.

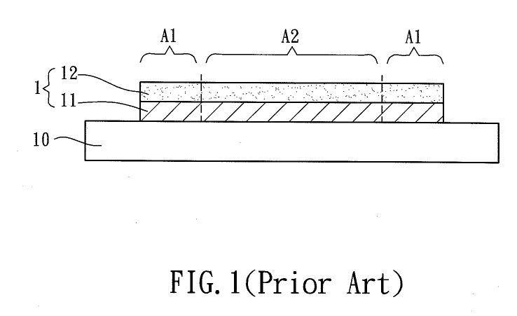

### DETAILED DESCRIPTION

The present invention will be apparent from the following detailed description, which proceeds with reference to the accompanying drawings, wherein the same references relate to the same elements.

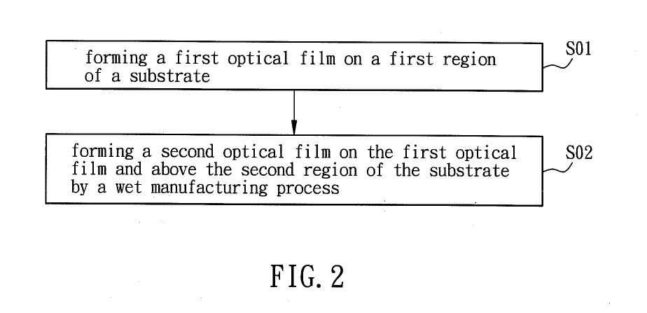

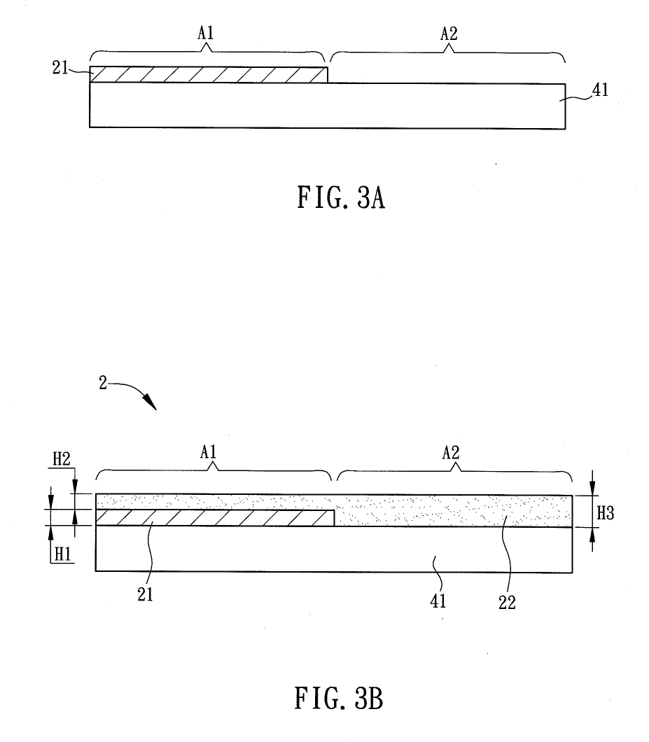

FIG. 2 is a flow chart of a manufacturing method of a composite optical film according an embodiment of the invention, and FIGS. 3A and 3B are schematic diagrams showing the manufacturing procedures of the composite optical film according the embodiment of the invention. With reference to FIGS. 2, 3A and 3B, the manufacturing method of a composite optical film 2 includes the steps S01 to S02.

Referring to FIGS. 2 and 3A, the step S01 is to form a first optical film 21 on a first region A1 of a substrate 41. Herein, the first region A1 is disposed adjacent to a second region A2. The material of the substrate 41 can be polymer (e.g. PET), metal or glass. The material of the first optical film 21 can be silicon oxide (e.g. SiO₂), aluminum oxide (e.g. Al₂O₃), magnesium fluoride (e.g. MgF₂), or their combinations. The refractive index of the first optical film 21 is between 1.3 and 1.7. The first optical film 21 can be formed by dry manufacturing process (e.g. PVD and CVD) or wet manufacturing process (e.g. dip coating, slit coating, spin coating, or spray coating). The manufacturing method of the first optical film 21 is not limited to these processes. In order to form the desired pattern of the first optical film 21 on the first region A1, it is possible to introduce a mask or a peelable mask to block the second region A2. Besides, it is also possible to use a photolithography process to form a high-resolution pattern on the first region A1.

With reference to FIG. 3B in view of FIG. 2, the step S02 is to form a second optical film 22 on the first optical film 21 and above the second region A2 of the substrate 41 by a wet manufacturing process. The wet manufacturing process includes, for example but not limited to, dip coating, slit coating, spin coating or spray coating. The material of the second optical film 22 can be silicon nitride (e.g. Si₃N₄), titanium oxide (e.g. TiO₂), niobium oxide (e.g. Nb₂O₅), tantalum oxide (e.g. Ta₂O₅), or their combinations. The refractive index of the second optical film 22 is between 1.8 and 2.4. In this step S02, the wet manufacturing process is used to form the second optical film 22 with the inherent leveling property, so that the manufactured second optical film 22 can be formed as a planarized layer. In other words, the top surface of the second optical film 22 can be planar. However, if the top surface of the second optical film 22 is not planar, the difference between the thickness H3 of the second optical film 22 within the second region A2 and the sum of the thicknesses (H1+H2) of the first optical film 21 and the second optical film 22 within the first region A1 is less than 20% of the sum of the thicknesses (H1+H2) of the first optical film 21 and the second optical film 22 within the first region A1. Herein, the thickness H1 of the first optical film 21 and the thickness (H2 or H3) of the second optical film 22 can be between 1 nm and 1 μm. For example, the thickness H1, H2 or H3 can be between 1 nm and 300 nm.

Accordingly, the composite optical film 2 in the first region A1 and that in the second region A2 can have different optical properties. Such optical properties can be, for example, chromaticity, transmission, reflectance, or refractive index. In this case, the first region A1 is a high reflective region, and the composite optical film 2 in the first region A1 can have a reflectance up to 60% (under visible light, 380-780 nm) for applying with decoration coating technology. The second region A2 is an anti-reflective region, and the composite optical film 2 in the second region A2 can have a reflectance lower to 1.2% (under visible light, 380-780 nm). Consequently, the composite optical film 2 of the embodiment can be configured with the optical films with different optical properties on or above the first region A1 and the second region A2 for providing different optical functions.

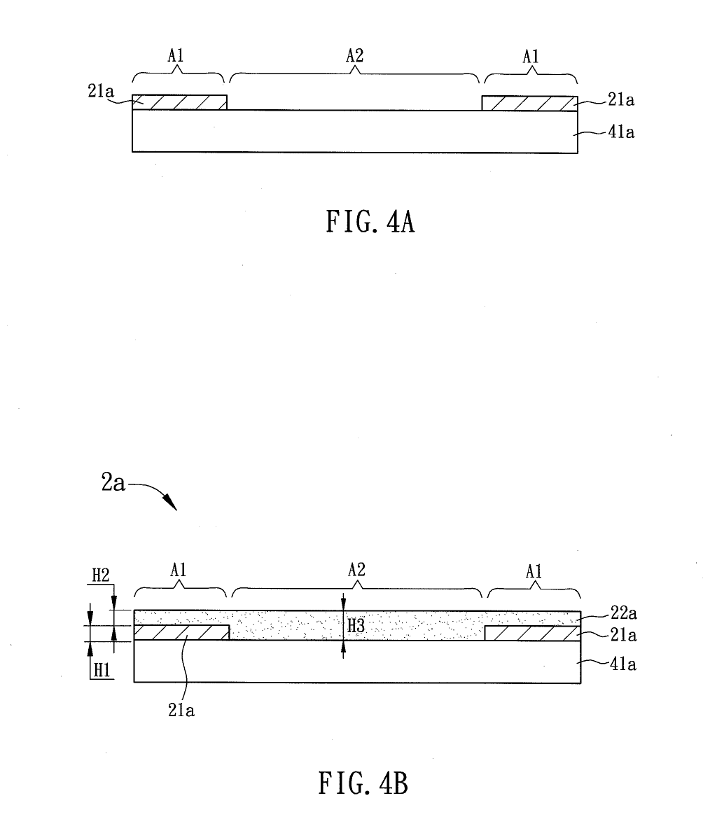

FIGS. 4A and 4B are schematic diagrams showing the manufacturing procedures of the composite optical film 2a according to another embodiment of the invention. Similarly, a first optical film 21a is formed on a first region A1 of a substrate 41a. The first region A1 can be disposed surrounding the second region A2, or surrounded by the second region A2. In this case, the first region A1 is disposed surrounding the second region A2. Then, a second optical film 22a is formed on the first optical film 21a and above the second region A2 of the substrate 41a by a wet manufacturing process. In this embodiment, the difference between the thickness H3 of the second optical film 22a within the second region A2 and the sum of the thicknesses (H1+H2) of the first optical film 21a and the second optical film 22a within the first region A1 is less than 20% of the sum of the thicknesses (H1+H2) of the first optical film 21a and the second optical film 22a within the first region A1. Herein, the thickness H1 of the first optical film 21a and the thickness (H2 or H3) of the second optical film 22a can be between 1 nm and 1 μm. For example, the thickness H1, H2 or H3 can be between 1 nm and 300 nm.

Accordingly, the first region A1 and the second region A2 of the composite optical film 2a have different optical properties.

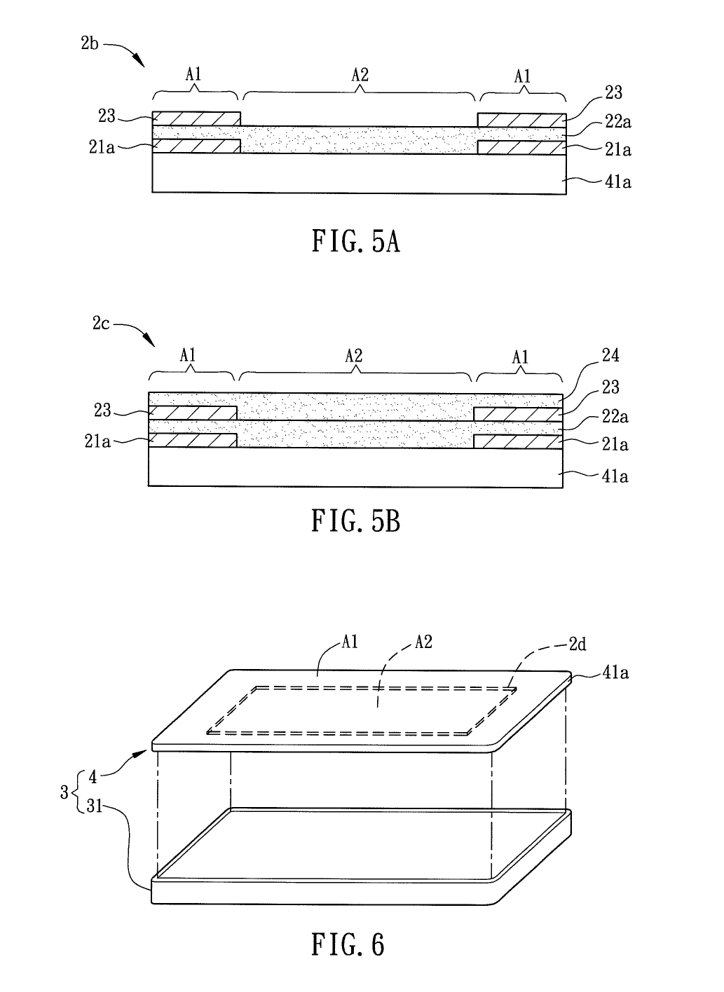

FIG. 5A is a schematic diagram showing a composite optical film 2b according to another embodiment of the invention. The composite optical film 2b further includes a third optical film 23 disposed over the second optical film 22a within the first region A1. The material of the third optical film 23 is the same as or different from that of the first optical film 21a. The configuration of the third optical film 23 can enhance the optical function of the composite optical film 2b in the first region A1 and thus increase the applications of the composite optical film 2b.

FIG. 5B is a schematic diagram showing a composite optical film 2c according to another embodiment of the invention. The composite optical film 2c further includes a fourth optical film 24 disposed on the third optical film 23 within the first region A1 and over the second optical film 22a within the second region A2. The material of the fourth optical film 24 is the same as or different from that of the second optical film 22a. The configuration of the fourth optical film 24 can enhance the optical function of the composite optical film 2c in the second region A2.

Accordingly, it is possible to form a plurality of optical films on the first region A1 and the second region A2 according to the requirements. Each optical film can be formed by disposing an optical layer on the first region A1 and then disposing another optical layer over the first region A1 and the second region A2. The desired optical films are formed by repeating the above processes. Otherwise, it is also possible to form each or some of the optical films by disposing an optical layer on the second region A2 and then disposing another optical layer over the first region A1 and the second region A2. The stacking of the optical films is not limited.

FIG. 6 is a schematic diagram of a display apparatus 3 according to an embodiment of the invention. For example, the display apparatus 3 is a touch display device, an LCD device, an OLED display device, or an E-paper. In this embodiment, the display apparatus 3 includes a main body 31 and a protective substrate 4. The protective substrate 4 includes a substrate 41a and a composite optical film 2d. The composite optical film 2d can be any one of the above-mentioned composite optical film 2, 2a, 2b, or 2c and can be formed by any one of the methods for manufacturing the composite optical film 2, 2a, 2b or 2c. The protective substrate 4 can be a decorated glass. That is, the first region A1 is a high reflective region, and the composite optical film 2d in the first region A1 can have a reflectance up to 60% (under visible light, 380-780 nm) corresponding to the black matrix area of the display apparatus for applying with decoration coating technology. The second region A2 is an anti-reflective region, and the composite optical film 2d in the second region A2 can have a reflectance lower to 1.2% (under visible light, 380-780 nm) corresponding to the active area of the display apparatus. The protective substrate 4 is further connected with the main body 31 (e.g. a touch panel or a display panel) to construct the display apparatus for a portable communication device, a portable communication device with touch control function, or a tablet computer with touch control function.

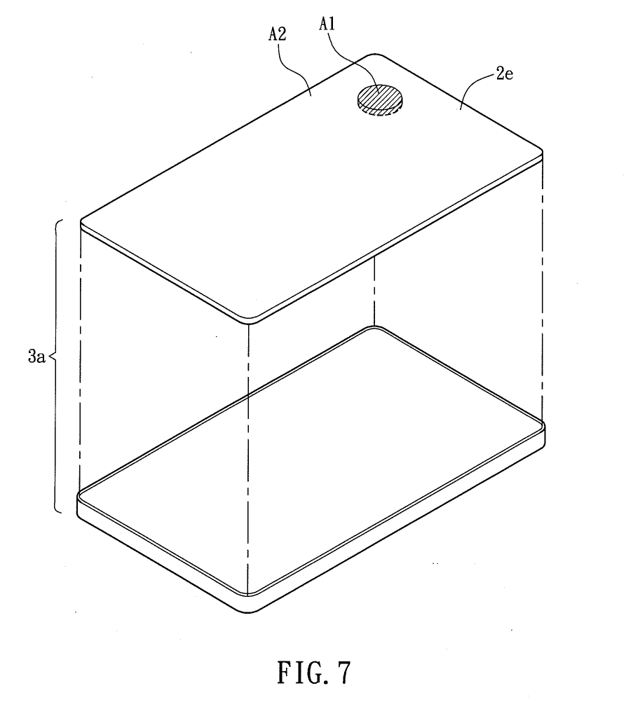

FIG. 7 is a schematic diagram of a display apparatus 3a according to another embodiment of the invention. For example, the display apparatus 3a is applied to a portable communication device. In this case, the composite optical film 2e within the first region A1 functions as an infrared ray receiving area (the wavelength of the infrared ray is larger than 700 nm), and the composite optical film 2e in the first region A1 has an IR (infrared ray) transmission larger than 90%. Thus, the first region A1 can be used as the IR receiving port of a mobile phone. In addition, the composite optical film 2e within the second region A2 functions as an anti-reflective area with a reflectance of about 2.7%. In this embodiment, the composite optical film 2e can be any one of the above-mentioned composite optical film 2, 2a, 2b, or 2c and can be formed by any of the methods for manufacturing the composite optical film 2, 2a, 2b or 2c. Moreover, a third region (not shown) can be configured surrounding the second region A2 for applying with decoration coating technology. Accordingly, the application of the composite optical film 2e is increased.

As mentioned above, the composite optical film of the display apparatus has a first optical film formed on a first region of a substrate, and a second optical film formed on the first optical film and over the second region of the substrate by wet manufacturing process. Accordingly, the composite optical film can provide different optical functions with respect to the first and second regions of the substrate. Thus, the application of the composite optical film can be increased, thereby improving the product competitiveness.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A composite optical film, which is disposed on a substrate, the substrate having a first region and a second region positioned adjacent to each other, the composite optical film comprising:
a first optical film disposed on the first region; and
a second optical film disposed on the first optical film and above the second region.

2. The composite optical film of claim 1, wherein the difference between the thickness of the second optical film within the second region and the sum of the thicknesses of the first optical film and the second optical film within the first region is less than 20% of the sum of the thicknesses of the first optical film and the second optical film within the first region.

3. The composite optical film of claim 1, wherein the optical property of the composite optical film in the first region is different from that of the composite optical film in the second region.

4. The composite optical film of claim 1, wherein the thickness of the first optical film is between 1 nm and 1 μm, and the thickness of the second optical film is between 1 nm and 1 μm.

5. The composite optical film of claim 1, wherein the second optical film is a planarized layer.

6. The composite optical film of claim 1, wherein the second optical film is formed by a wet manufacturing process.

7. The composite optical film of claim 1, further comprising:
a third optical film disposed over the second optical film within the first region or the second region.

8. A manufacturing method of a composite optical film, comprising the steps of:
forming a first optical film on a first region of a substrate, wherein the first region is disposed adjacent to a second region; and
forming a second optical film on the first optical film and above the second region by a wet manufacturing process.

9. The manufacturing method of claim 8, further comprising a step of:
forming a third optical film disposed above the second optical film within the first region or the second region.

10. A display apparatus, comprising:
a main body; and
a protective substrate disposed at one side of the main body, and comprising:
a substrate having a first region and a second region positioned adjacent to each other, and
a composite optical film comprising a first optical film and a second optical film, wherein the first optical film is disposed on the first region, and the second optical film is disposed on the first optical film and above the second region.

11. The display apparatus of claim 10, wherein the difference between the thickness of the second optical film within the second region and the sum of the thicknesses of the first optical film and the second optical film within the first region is less than 20% of the sum of the thicknesses of the first optical film and the second optical film within the first region.

12. The display apparatus of claim 10, wherein the optical property of the composite optical film in the first region is different from that of the composite optical film in the second region.

13. The display apparatus of claim 10, wherein the first region surrounds the second region.

14. The display apparatus of claim 13, wherein the refractive index of the first optical film is between 1.3 and 1.7.

15. The display apparatus of claim 13, wherein the refractive index of the second optical film is between 1.8 and 2.4.

16. The display apparatus of claim 10, wherein the second region surrounds the first region.

17. The display apparatus of claim 10, wherein the thickness of the first optical film is between 1 nm and 1 μm, and the thickness of the second optical film is between 1 nm and 1 μm.

18. The display apparatus of claim 10, wherein the second optical film is a planarized layer.

19. The display apparatus of claim 10, wherein the second optical film is formed by a wet manufacturing process.

20. The display apparatus of claim 10, wherein the composite optical film further comprises:
a third optical film disposed over the second optical film within the first region or the second region.
